(19) United States
(12) Patent Application Publication
(10) Pub. No.: US 2015/0332311 A1
(43) Pub. Date: Nov. 19, 2015

(54) OPTIMIZED PLACEMENT OF DIGITAL OFFERS

(71) Applicant: Coupons.com Incorporated, Mountain View, CA (US)

(72) Inventors: KAVEL PATEL, SANTA CLARA, CA (US); SAJJIT THAMPY, SUNNYVALE, CA (US); MICHAEL WALSH, SAN FRANCISCO, CA (US)

(21) Appl. No.: 14/704,896

(22) Filed: May 5, 2015

Related U.S. Application Data
(60) Provisional application No. 61/993,653, filed on May 15, 2014.

(51) Int. Cl. G06Q 30/02

(52) U.S. Cl. CPC G06Q 30/0244

(57) ABSTRACT

Various embodiments describe systems and methods for optimizing the placement of digital offers on a digital medium.

### CROSS-REFERENCE TO RELATED APPLICATIONS; BENEFIT CLAIM

This application claims the benefit of Provisional Application No. 61/993,653 filed May 15, 2014, the entire contents of which is hereby incorporated by reference as if fully set forth herein, under 35 U.S.C. §119(e). The applicant(s) hereby rescind any disclaimer of claim scope in the parent application or the prosecution history thereof and advise the USPTO that the claims in this application may be broader than any claim in the parent application.

### TECHNICAL FIELD

Embodiments relate generally to the generation, processing, storage, management, optimization, placement, usage, distribution and/or delivery of electronic offers, including digital coupons and other digital promotional vehicles.

### BACKGROUND

Product manufacturers, retailers and/or other entities engaged in the generation, processing, storage, management, optimization, placement, usage, distribution and/or delivery of electronic offers, including digital coupons and other digital promotional vehicles, sometimes make available such digital offers to consumers via websites or other digital media.

As the number of electronic offers made available to consumers via such websites or digital media increases, and as the content and layout of such webpages or other digital media become more complex, there is a risk that the selection and consumption of electronic offers by such consumers is not optimal.

Consequently, there is a need for improved methods and systems for generating, processing, storing, managing, optimizing, placing, using and/or delivering electronic offers, for enhancing and customizing the electronic offer experience of consumers in general, for increasing the value and benefits derived by consumers from electronic offers, for improving the ability of offer providers, offer distributors and retailers to customize and optimize the electronic offer selection, delivery, utilization, management, monetization and/or redemption analysis, and/or for otherwise increasing the efficiency and financial return of the electronic offer industry and market.

### BRIEF DESCRIPTION OF THE DRAWINGS

The accompanying figures, which together with the detailed description below are incorporated in and form part of the specification, serve to further illustrate various embodiments and to explain various principles and advantages, all in accordance with example embodiments of the present inventions.

FIG. 1 illustrates a technology platform through which digital offers may be processed in accordance with various embodiments;

FIG. 2 illustrates a data processing system that may be used in connection with various embodiments.

FIG. 3 illustrates a system for optimizing the placement of digital offers within a digital medium in accordance with an embodiment.

FIG. 4 illustrates a method, process and flow for optimizing the placement of digital offers within a digital medium in accordance with an embodiment.

### DESCRIPTION OF EXAMPLE EMBODIMENTS

Various embodiments describe systems and methods for optimizing the placement of digital offers on a digital medium.

In various embodiments, such systems and methods may comprise logic modules and/or steps for receiving a set of historical transaction records and a set of offer data.

In various implementations, the historical transaction records include at least one of the following: a universal product code, a quantity of product purchased, a number of items purchased, a transaction amount, at least a portion of a credit card number used, at least a portion of an account identifier, a payment identifier, a secure payment hash key, a data processing system or facility, time, date, one or more offers activated or redeemed, a consumer name, at least a portion of a phone number, a pin number, a password, a code, a loyalty card number, RFID data, a device identifier, one or more items that were purchased in a previous, concurrent or subsequent transaction, a transaction number, consumer tenure, consumer past behavior, consumer purchasing tendencies, the type and number of digital coupons activated, redeemed or printed by a consumer in a particular timeframe, the number of unique offers activated, redeemed or printed by a consumer, consumer search behavior, consumer purchase transaction behavior, consumer web browsing behavior, consumer digital offer activation behavior, consumer digital offer redemption behavior, an IP number of a digital processing system, a Universal Product Code (UPC), a stock-keeping unit (SKU) number, a taxonomical categorization, a product name, a product description, nutritional information of a product, a product specifications, a product price history, or an inventory level.

In various implementations, the offer data may include at least one of the following: an offer provider identity, a historical or projected impact of the offer on sales of an item, a historical or projected offer redemption rate, a historical or projected profit per offer impression, a historical or projected profit margin, a historical trend in offers made available by an offer provider, a historical or projected offer volume, a historical or projected number of offer activations, a historical or projected number of offer impressions, a historical or projected number of offer redemptions, a historical or projected number of products sold, a historical or projected offer yield, a historical or projected profit figure, a historical or projected trend in offers made available by an offer provider, a historical or projected profit margin for an offer distributor, a historical or projected profit margin for an offer provider, a historical or projected impact of an offer on other offers, a historical or projected impact of an offer on consumer behavior, the savings value of a digital offer, the click-through rate of a digital offer, the household penetration of a product offered by a digital offer, an offer provider identity, a historical or projected impact of an offer on sales of an item, a historical or projected offer redemption rate, or a historical or projected profit per offer impression.

In various embodiments, such systems and methods may further comprise logic modules and/or steps for placing a set of digital offers on a digital medium. In various implementations, the digital medium may be a website, a portion of a web page, a software application running on a data processing system, an advertising display, a television or video device, a television or video broadcast, an electronic game, a kiosk, or a wearable device with display capability.

In various embodiments, such systems and methods may further comprise logic modules and/or steps for receiving a set of offer consumption data. In various implementations, the offer consumption data may include information relating to at least one interaction between a consumer and the set of digital offers. Examples of such data relating to the at least one interaction between the consumer and the set of digital offers may include a record of the number of electronic offers that were activated, clipped, clicked, saved, viewed, or redeemed by a consumer after accessing such electronic offers through the digital medium.

In various embodiments, such systems and methods may further comprise logic modules and/or steps for optimizing the placement of at least a subset of the digital offers on the digital medium for a consumer. In various implementations, the optimization may be based on one or more of the following: at least a subset of the historical transaction records; at least a subset of the offer data; and at least a subset of the offer consumption data.

In various implementations, the optimization may utilize at least one of the following: a machine learning algorithm that arrives at an optimal sort order or placement of the electronic offers within the digital medium; evaluating the probability that a particular consumer would print, activate and/or redeem a particular electronic offer; a machine learning phase; or determining for a particular consumer at least one of the following: what digital offers were presented to that consumer; offer data associated with digital offers presented to the consumer; and an action taken by the consumer in connection with the digital offers presented to the consumer.

In various implementations, the optimization may include at least one of the following: using a training data set to train a machine learning algorithm; using a bagged set of regression trees as the basis for a machine learning algorithm; using a regularized logistic regression as the basis for a machine learning algorithm; using a testing data set to derive parameters for tuning a machine learning algorithm; or generating a probability score for a particular consumer that seeks to predict the probability that the consumer will be interested in a particular digital offer.

In various implementations, the optimization may include applying a set of heuristics to supplement a machine learning algorithm analysis. As an example, the application of the set of heuristics may include factoring one or more of the heuristics using a function. In various implementations, one or more may apply: the function may be a sigmoid function; the input to the function may be a set of parameters relevant to a heuristic; or the output of the function may be used to promote or demote digital offers in the placement of offers within the digital medium.

In various implementations, the optimization may include at least one of the following: evaluating the revenue associated with the activation, recommendation, and/or redemption of one or more previous digital offers; biasing the placement of offers to be more favorable to an offer distributor, an offer provider, and/or a consumer; comparing the historical performance of an offer to average offer performance across a plurality of offers; determining a plurality of optimized frameworks for the placement of digital offers by optimizing one or more metrics to be more favorable to a set of consumers, a set of retailers, and/or a set of offer providers; artificially increasing the placement ranking of a particular offer; applying further weights to the ranking of one or more digital offers; adjusting the placement of one or more digital offers based on a historical or projected impact of a digital offer on sales of an item, a historical or projected offer redemption rate, a historical or projected profit per offer impression, a historical or projected profit margin, a historical or projected offer volume, a historical or projected offer yield, a historical trend in offers made available by an offer provider, a historical or projected profit margin for the offer distributor, a historical or projected profit margin for an offer provider, a historical or projected impact of an offer on other offers, or a historical or projected impact of an offer on consumer behavior.

While the specification concludes with claims defining various aspects of the invention that are regarded as novel, the following description in conjunction with the figures may help further understand the various embodiments.

In the following description, for the purposes of explanation, numerous details are set forth in order to provide a thorough understanding of various embodiments of the present invention. It will be apparent, however, that various embodiments of the present invention may be practiced without these specific details. In other instances, well-known structures and devices are shown in block diagram form in order to avoid unnecessarily obscuring the present invention.

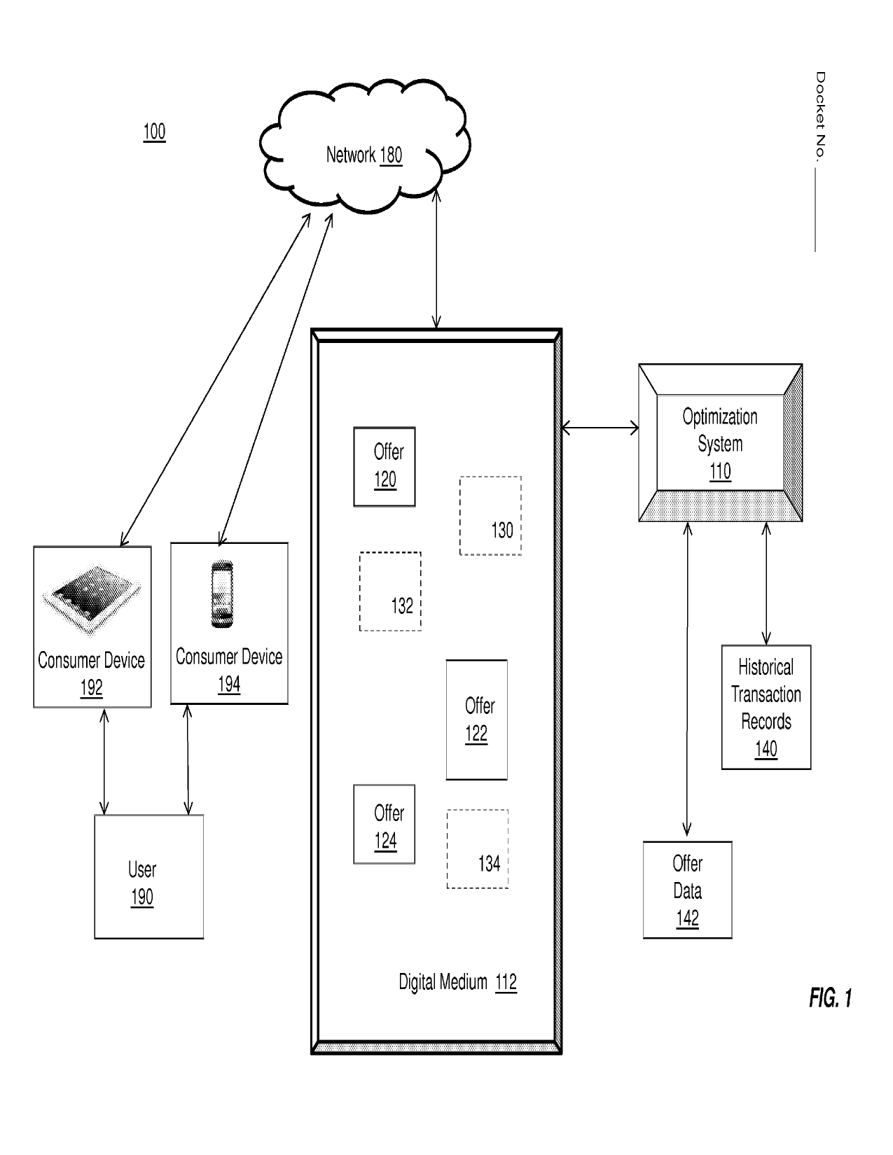

FIG. 1 shows a system 100 adapted to optimize the placement of one or more electronic offers presented to a user. In system 100, a set of digital offers, illustrated as electronic offers 120, 122 and 124, are presented to a user via a digital medium 112.

In various implementations, there may be one, two or many more electronic offers that are presented to one or more users. There is virtually no limitation to the number of electronic offers that may be presented to users, depending on the characteristics of the digital medium 112. For example, a web page may accommodate a larger number of electronic offers, while a digital display board in a public area, a customer-facing point of sale terminal, or a mobile phone may accommodate less electronic offers at the same time.

In general, electronic offers are digital marketing vehicles that product manufacturers, retailers or other entities use to attempt to influence customer behavior. Electronic offers may be targeted to the user to which they are being presented. A digital offer may be construed to be a promise by an offer provider to provide a consumer with a benefit under a certain set of implicit or explicit conditions, sometimes denoted as “terms of the offer.”

Offer providers that are engaged in the generation, distribution and/or other processing of electronic offers may include product manufacturers, merchants, and any other entity engaged in marketing.

Benefits that may be provided through an electronic offer may include a monetary gift, a discount applied to the purchase of one or more products or services, free products and/or services, access to additional offers, etc.

Terms of offers may include actions that the consumer must perform, a specific set of item(s) that must be purchased by the consumer, a specific amount of money that must be spent by the consumer, a timeframe during which the offer is valid, etc.

To exercise the benefit of an offer, a consumer usually “redeems” the offer through a redemption mechanism. The redemption of an offer often takes place during a transaction between the consumer and a retailer. When the consumer wishes to engage in a transaction, the retailer may determine whether the conditions of the offer have been met. If so, the retailer, which may be any merchant or other entity that sells products or services, provides the benefit of the electronic offer to the consumer on behalf of the offer provider.

One example of an electronic offer is a digital coupon. In various embodiments, a digital coupon is a digital certificate, document, or other electronic construct that entitles a consumer to accept an offer described or referenced by the digital coupon, thereby realizing the benefit of the offer. Digital coupons and other electronic offers may be redeemed electronically (e.g., as part of an electronic purchase transaction), or may be printed and converted to a physical document, for later use in a physical in-store transaction.

The process of the consumer accepting an electronic offer by presenting, using, referencing, or otherwise providing an electronic offer in connection with purchasing, contracting, or otherwise transacting with another party is sometimes denoted “redemption.” For example, a consumer may redeem a digital coupon or other electronic offer by electronically adding it to an online transaction, or by entering a corresponding code during a checkout process for an online transaction. In exchange of the redemption of an electronic offer, the consumer is entitled to receive the benefit of the offer, such as a discounted price, an item, a service or a gift.

Prior to redemption of an electronic offer, a consumer may “activate” an offer. Activation of an electronic offer means that a consumer is indicating an interest in possibly redeeming that offer, or is otherwise selecting or saving the offer for further processing and/or later use. An offer can become activated in response to a number of triggering events, including in response to a consumer device (such as consumer devices 192 or 194 illustrated in the embodiment of FIG. 1) requesting activation of the electronic, upon a consumer printing or digitally clipping an offer, in response to a specific request from an offer provider or other entity, in response to an automated activation process such as schedule or event-based triggers, based on an automatic activation process managed by an offer management system, or through any other suitable electronic offer activation mechanisms. Since activation of an electronic offer often involves an electronic coupon, the acts of “activating a coupon” and “generating a coupon” for a consumer should be understood to refer to or imply the activation of the corresponding offer for that consumer. In an embodiment, a record describing an activated offer is considered to be equivalent to a digital coupon for that offer. In an embodiment, a record describing an activated offer may be used to validate a printed coupon. In an embodiment, a digital coupon is generated on-demand, in response to an offer provider determining that a transaction involving the corresponding consumer entity record matches the terms for an offer that has been activated for the consumer entity. In some embodiments, certain offers are “globally activated” for all consumers, in that a consumer may redeem the offer without the offer having been specifically activated for that consumer entity.

In the embodiment of FIG. 1, the one or more electronic offers 120, 122 and 124 are presented to one or more consumers through a digital medium 112. In various embodiments, the digital medium 112 may be a website, a portion of a web page, a mobile application running on a mobile phone, tablet or other data processing system, a digital advertising display (e.g., an advertising display in a store, mall or other public or private area), a television or other video device or broadcast, an electronic game (e.g., contextual advertising or other data displayed within a game played on a data processing system), a kiosk, a wearable device with display capability, or any other digital medium suitable for the display of advertisements or other promotional content.

In various embodiments, the electronic offers 120, 122 and 124 may be arranged in an organized form (e.g., grid of rows and/or columns) on the digital medium 112. In some embodiments, electronic offers 120, 122 and 124 may be freely arranged in the space available on the digital medium 112.

In addition to the one or more electronic offers 120, 122 and 124, digital medium 112 often includes additional content. Such additional content is illustrated in FIG. 1 as other content items 130, 132 and 134. In various embodiments, the content items 130, 132 and 134 may be one or more pieces of content that may include one or more of: text, pictures, video, promotional content, and/or other information. In one embodiment, one or more of the content items 130, 132 and 134 may be electronic offers. In one embodiment, one or more of the content items 130, 132 and 134 may be interactive content, which can be used by a user to initiate actions such as activation or redemption of an electronic offer, navigation to a web page or to another location, or initiation of a command to perform an action (e.g., start or end a software application).

As the complexity and the amount of information displayed by the digital medium 112 increases, the ability of the consumers to view, comprehend and/or interact with specific electronic offers may be negatively impacted. For example, as the layout of the digital medium 112 becomes more complicated, with multiple areas dedicated to various types of content, particular electronic offers that an offer provider seeks to emphasize or promote may become marginalized or obscured. Analogously, as the number of electronic offers 120, 122 and 124 that are intended to be promoted to consumers increases, or as the amount of additional content displayed on the digital medium 112 grows, it becomes more difficult for an offer provider to ensure that specific electronic offers are viewed, activated and/or redeemed by a consumer.

To address this issue, optimization system 110 shown in FIG. 1 is adapted to optimize the placement of specific electronic offers within the digital medium 112. For example, depending on various relevant factors, an offer provider may desire that a particular user should see electronic offer 120 at the top of a page, with electronic offer 124 immediately below. For a different user, however, the offer provider may desire that electronic offer 120 should be omitted completely, while electronic offer 124 should be displayed in a prominent location at the top of the page.

In various embodiments, there may be a large number of combinations and permutations in which various electronic offers and content may be displayed within a digital medium, such as digital medium 112. For example, depending on the identity of a user and other factors, a particular electronic offer may be promoted above other content, may be displayed more prominently (e.g., magnified, or with a different color or graphical profile), may be deemphasized relative to another electronic offer or other content, or may not be displayed at all. In one embodiment, the full set of digital offers, or a subset of the digital offers is displayed to different consumers in a different sorted order for each consumer, in manner that is personalized for each consumer.

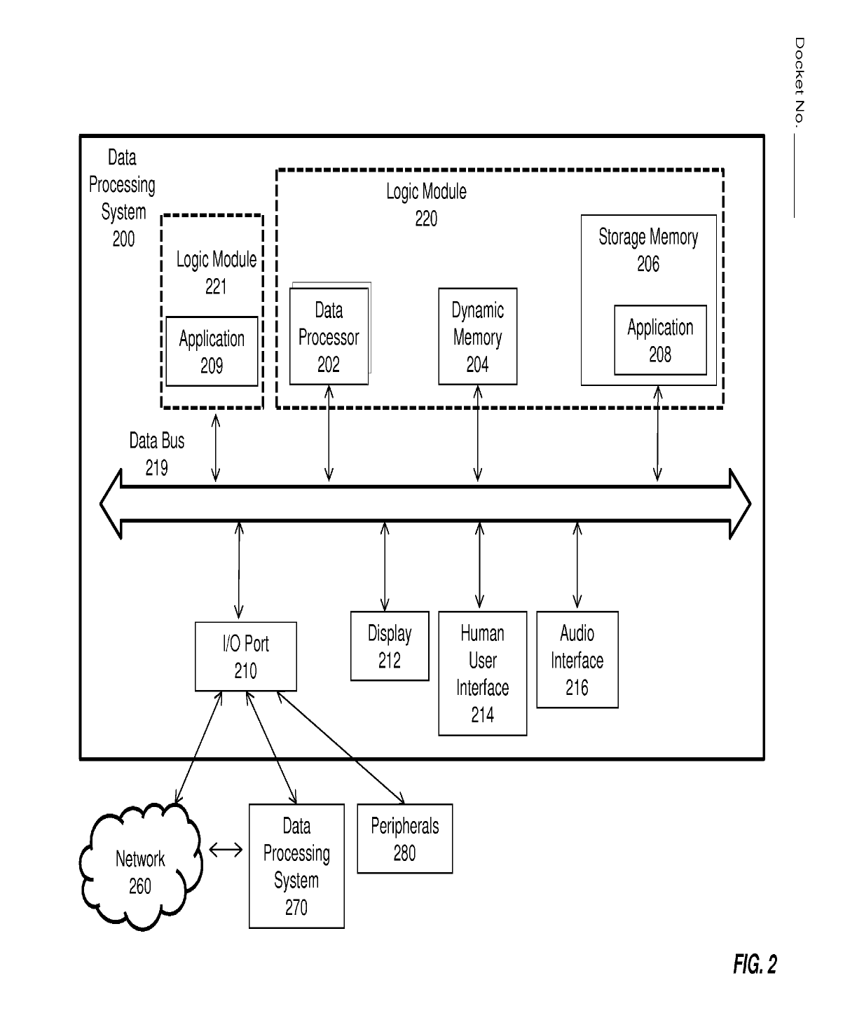

In various embodiments, the optimization system 110 may be a data processing system or a logic module. In various embodiments, the optimization system 110 may be incorporated in a data processing system that also includes the digital medium 110, or may be located remotely from the digital medium 112 and communicate with the digital medium 112 via one or more networks or communication channels. A more detailed description of data processing systems, logic modules, networks and communication channels is provided in connection with the embodiment of FIG. 2.

In one embodiment, the optimization system 110 optimizes the placement of one or more electronic offers 120, 122 and 124 within a digital medium 112 based on a set of historical transaction records 140 relating to past consumer transactions.

In various embodiments, historical transaction records 140 may include various classes of information that relate to users, transactions, vendors, payment processing, and other aspects of electronic or physical commerce. As an example, historical transaction records 140 may be, or may include contextual transaction data that was generated in connection with previous transactions, has been stored in a memory, may have been further processed and refined, and which can now be retrieved and used as a basis for further data processing and decision making. As another example, historical transaction records 140 may be, or may include transaction data, consumer data, product data, and offer data. Historical transaction records 140 may include contextual transaction data or any associated data or derivative data that has been generated up to a current moment in time.

Historical transaction records 140 may also include consumer records that can be used to match transaction data with specific consumers, such as user 190. Examples of such consumer records include account identifiers, credit card numbers, names, pin numbers, passwords, personal codes, loyalty card numbers, email addresses, phone numbers, location information, etc. Such consumer records may be used in full or in partial form (e.g., a full phone number or only a few digits of a phone number).

Historical transaction records 140 may also include consumer records that can be used to ascertain consumer behavior, interests, preferences, and other consumer attributes, such as tenure, past behavior and purchasing tendencies, the type and number of digital coupons activated, redeemed or printed in a particular timeframe, the number of unique offers activated, redeemed or printed, etc.

In an embodiment, historical transaction records 140 may include identifying data that may be used to associate consumer devices (such as user devices 192) with specific consumers, including IP addresses or other device identifiers, user names, passwords, phone numbers, and location information.

In an embodiment, historical transaction records 140 may be periodically seeded with account data collected directly from retailers or other business entities, including social media networks and other websites. In an embodiment, historical transaction records 140 may include consumer records that are updated based on ongoing use of a loyalty card. In an embodiment, historical transaction records 140 may include registration information updated on an ongoing basis using data from consumer interactions with electronic offers or consumer purchase transactions. In an embodiment, historical transaction records 140 may include information obtained through a registration process during which consumers optionally enter information such as names, loyalty card identifiers, addresses, and other personal or behavioral information.

In an embodiment, historical transaction records 140 may include information about a plurality of different items, including both goods and services, that may be found in receipts or that may be the subject of an offer. The information may include identifiers such as Universal Product Codes (UPCs) and/or stock-keeping unit (SKU) numbers, taxonomical categorizations, names, descriptions, nutritional information, product specifications, price histories, inventory levels, and/or any other suitable metadata. The product information may be populated and maintained using any suitable data collection technique. For example, the product information may be collected from and/or updated by retailers in periodic batch synchronizations of retailer product databases. As another example, product information may be collected from data mining of retailer or manufacturer websites. The product information may also or instead be updated as part of analyzing transaction data.

In an embodiment, historical transaction records 140 may include information determined for a particular consumer, including search behavior, purchase transaction behavior, web browsing behavior, digital offer activation behavior, or digital offer redemption behavior.

In general, historical transaction records 140 may include virtually any information that relates to users, transactions, vendors, payment processing, and any other aspects of electronic or physical commerce. As an example, historical transaction records 140 may be, or may include contextual transaction data that was generated in connection with previous transactions. In various embodiments, historical transaction records 140 may include any of a variety of information related to one or more past consumer transactions conducted within a facility owned, controlled or operated by a retailer, including without limitation SKU-level transaction details such as universal product codes and quantities purchased, total number of items purchased, transaction amounts, payment details (e.g., a credit card number, a payment identifier, a secure payment hash key), information about a data processing system, logic module or facility where the transaction takes place (e.g., terminal identifier or store identifier), time, date, offers applied during the transactions, information relating to the customer who conducted the transaction (e.g., a name, a phone number, a pin number, a password, a code, a loyalty card number, other biometric or personal identification data, etc.), RFID data, a device identifier, items that were purchased in a previous, concurrent or subsequent transaction, a transaction number, and other similar information.

In one embodiment, the optimization system 110 optimizes the placement of one or more electronic offers 120, 122 and 124 within a digital medium 112 based on a set of offer data 142 illustrated in the embodiment of FIG. 1.

In one embodiment, offer data 142 may include an offer provider identity, a historical or projected impact of the offer on sales of an item, a historical or projected offer redemption rate, a historical or projected profit per offer impression, a historical or projected profit margin, a historical trend in offers made available by the offer provider, and other similar types of information.

In one embodiment, offer data may include a historical or projected offer volume (e.g., the total number of offer activations, offer impressions, offer redemptions and/or products sold), a historical or projected offer yield (e.g., a total profit figure associated with an offer after taking into account the total number of sold products corresponding to that offer, offer activations, offer impressions and/or offer redemptions), a historical trend in offers made available by the offer provider, a historical or projected profit margin for the offer distributor and/or for the offer provider, a historical or projected impact of the offer on other offers, a historical or projected impact of the offer on consumer behavior, and other similar types of information.

Offer data may also include the savings value of a digital offer, the click-through rate of a digital offer, the household penetration of a product offered by a digital offer, etc.

In the embodiment of FIG. 1, optimization system 110 optimizes the placement of one or more of the electronic offers 120, 122 and 124 within the digital medium 112 and displays the optimized placement to one or more users, such as, user 190. The placement of the one or more of the electronic offers 120, 122 and 124 may differ only slightly for different users, or may be substantially different for different users, depending on various historical transaction records and offer data taken into consideration. In one embodiment, the placement of the one or more of the electronic offers 120, 122 and 124 may be substantially the same for a number of users (e.g., for anonymous users whose identity has not been resolved yet, or as part of an optimization algorithm that is designed to start with no initial conditions).

In the embodiment of FIG. 1, the user 190 interacts with the digital medium 112 through a data processing system, illustrated as user devices 192 and 194. In various embodiments, the user devices 192 and 194 may be a desktop computer, laptop computer, netbook, electronic notebook, ultra mobile personal computer (UMPC), electronic tablet or similar device (including any tablet using an iOS™ operating system released by Apple Computer™, Android™ operating system released by Google Inc.™ or Windows™ operating system released by Microsoft Corporation™), client computing device, client terminal, client console, server computer, server system, server terminal, cloud computing system, parallel processing or other distributed computing system, virtual machine, remote computer, mobile telephone, smartphone or similar device (including any smartphone using an iOS™ operating system released by Apple Computer™, Android™ operating system released by Google Inc.™ or Windows™ operating system released by Microsoft Corporation™), wearable computer, head mounted computer or display (such as the Google Glass device commercialized by Google Inc.™), personal digital assistant, personal digital organizer, handheld device, networking device, or any other device, component, module, subsystem or system capable of processing electronic data, or any combination of the foregoing.

In one embodiment, a user data processing system, such as a user device 192, accesses content displayed by digital medium 112 through a communication channel or through a communication network, such as network 180 shown in FIG. 1. More details about communication networks are provided in connection with the embodiment of FIG. 2.

FIG. 2 shows a representation of a data processing system 200 that may be used in connection with various embodiments described and/or claimed in this patent and which may be configured to execute instructions for performing functions and methods described and/or claimed in this patent. In one implementation, the data processing system 200 includes the digital medium 112 and/or the optimization system 110 described in connection with the embodiment of FIG. 1.

The data processing system 200 includes a data processor 202. The data processor 202 represents one or more general-purpose data processing devices such as a microprocessor or other central processing unit. More particularly, the processing device may be a complex instruction set computing (CISC) microprocessor, a reduced instruction set computing (RISC) microprocessor, a very long instruction word (VLIW) microprocessor, a processor implementing other instruction sets, or a processor implementing a combination of instruction sets, whether in a single core or in a multiple core architecture. Data processor 202 may also be or include one or more special-purpose processing devices such as an application specific integrated circuit (ASIC), a field programmable gate array (FPGA), a digital signal processor (DSP), network processor, any other embedded processor, or the like. The data processor 202 may execute instructions for performing operations and steps in connection with various embodiments.

The data processing system 200 further includes a dynamic memory 204, which may be designed to provide higher data read speeds. Examples of dynamic memory 204 include dynamic random access memory (DRAM), synchronous DRAM (SDRAM) memory, read-only memory (ROM) and flash memory. The dynamic memory 204 may be adapted to store all or part of the instructions of a software application, as these instructions are being executed or may be scheduled for execution by data processor 202. In some implementations, the dynamic memory 204 may include one or more cache memory systems that are designed to facilitate lower latency data access by the data processor 202.

In general, unless otherwise stated or required by the context, when used in connection with a method or process, data processing system, or logic module, the words “adapted” and “configured” are intended to describe that the respective method, data processing system or logic module is capable of performing the respective functions by being appropriately adapted or configured (e.g., via programming, via the addition of relevant components or interfaces, etc.), but are not intended to suggest that the respective method, data processing system or logic module is not capable of performing other functions. For example, unless otherwise expressly stated, a logic module that is described as being adapted to process a specific class of information will not be construed to be exclusively adapted to process only that specific class of information, but may in fact be able to process other classes of information and to perform additional functions (e.g., receiving, transmitting, converting, or otherwise processing or manipulating information).

In this exemplary embodiment, the data processing system 200 further includes a storage memory 206, which may be designed to store larger amounts of data. Examples of storage memory 206 include a magnetic hard disk and a flash memory module. In various implementations, the data processing system 200 may also include, or may otherwise be configured to access one or more external storage memories, such as an external memory database or other memory data bank, which may either be accessible via a local connection (e.g., a wired or wireless USB, Bluetooth, or WiFi interface), or via a network (e.g., a remote cloud-based memory volume).

A storage memory may also be denoted a memory medium, storage medium, dynamic memory, or memory. In general, a storage memory, such as the dynamic memory 204 and the storage memory 206, may include any chip, device, combination of chips and/or devices, or other structure capable of storing electronic information, whether temporarily, permanently or quasi-permanently. A memory medium could be based on any magnetic, optical, electrical, mechanical, electromechanical, MEMS, quantum, or chemical technology, or any other technology or combination of the foregoing that is capable of storing electronic information. A memory medium could be centralized, distributed, local, remote, portable, or any combination of the foregoing. Examples of memory media include a magnetic hard disk, a random access memory (RAM) module, an optical disk (e.g., DVD, CD), and a flash memory card, stick, disk or module.

A software application or module, and any other computer executable instructions, may be stored on any such storage memory, whether permanently or temporarily, including on any type of disk (e.g., a floppy disk, optical disk, CD-ROM, and other magnetic-optical disks), read-only memory (ROM), random access memory (RAM), EPROM, EEPROM, magnetic or optical card, or any other type of media suitable for storing electronic instructions.

In general, a storage memory could host a database, or a part of a database. Conversely, in general, a database could be stored completely on a particular storage memory, could be distributed across a plurality of storage memories, or could be stored on one particular storage memory and backed up or otherwise replicated over a set of other storage memories. Examples of databases include operational databases, analytical databases, data warehouses, distributed databases, end-user databases, external databases, hypermedia databases, navigational databases, in-memory databases, document-oriented databases, real-time databases and relational databases.

One or more software applications 208 may be stored on storage memory 206 in whole or in part. In general, a software application, also denoted a data processing application or an application, may include any software application, software module, app, mobile app, function, procedure, method, class, process, or any other set of software instructions, whether implemented in programming code, firmware, or any combination of the foregoing. A software application may be in source code, assembly code, object code, or any other format. In various implementations, an application may run on more than one data processing system (e.g., using a distributed data processing model or operating in a computing cloud), or may run on a particular data processing system or logic module and may output data through one or more other data processing systems or logic modules.

The exemplary data processing system 200 may include one or more logic modules 220 and/or 221, also denoted data processing modules, or modules. Each logic module 220 and/or 221 may consist of (a) any software application, (b) any portion of any software application, where such portion can process data, (c) any data processing system, (d) any component or portion of any data processing system, where such component or portion can process data, and (e) any combination of the foregoing. In general, a logic module may be configured to perform instructions and to carry out the functionality of one or more embodiments of the present invention, whether alone or in combination with other data processing modules or with other devices or applications. Logic modules 220 and 221 are shown with dotted lines in FIG. 2 to further emphasize that data processing system 200 may include one or more logic modules, but does not have to necessarily include more than one logic module.

As an example of a logic module comprising software, logic module 221 shown in FIG. 2 consists of application 209, which may consist of one or more software programs and/or software modules. Logic module 221 may perform one or more functions if loaded on a data processing system or on a logic module that comprises a data processor.

As an example of a logic module comprising hardware, the data processor 202, dynamic memory 204 and storage memory 206 may be included in a logic module, shown in FIG. 2 as exemplary logic module 220. Examples of data processing systems that may incorporate both logic modules comprising software, and logic modules comprising hardware, include a desktop computer, a mobile computer, or a server computer, each being capable of running software to perform one or more functions defined in the respective software.

In general, functionality of logic modules may be consolidated in fewer logic modules (e.g., in a single logic module), or may be distributed among a larger set of logic modules. For example, separate logic modules performing a specific set of functions may be equivalent with fewer or a single logic module performing the same set of functions. Conversely, a single logic module performing a set of functions may be equivalent with a plurality of logic modules that together perform the same set of functions. In the data processing system 200 shown in FIG. 2, logic module 220 and logic module 221 may be independent modules and may perform specific functions independent of each other. In an alternative embodiment, logic module 220 and logic module 221 may be combined in whole or in part in a single module that perform their combined functionality. In an alternative embodiment, the functionality of logic module 220 and logic module 221 may be distributed among any number of logic modules. One way to distribute functionality of one or more original logic modules among different substitute logic modules is to reconfigure the software and/or hardware components of the original logic modules. Another way to distribute functionality of one or more original logic modules among different substitute logic modules is to reconfigure software executing on the original logic modules so that it executes in a different configuration on the substitute logic modules while still achieving substantially the same functionality. Examples of logic modules that incorporate the functionality of multiple logic modules and therefore can be construed themselves as logic modules include system-on-a-chip (SoC) devices and a package on package (PoP) devices, where the integration of logic modules may be achieved in a planar direction (e.g., a processor and a storage memory disposed in the same general layer of a packaged device) and/or in a vertical direction (e.g. using two or more stacked layers).

The exemplary data processing system 200 may further include one or more input/output (I/O) ports 210 for communicating with other data processing systems 270, with other peripherals 280, or with one or more networks 260. Each I/O port 210 may be configured to operate using one or more communication protocols. In general, each I/O port 210 may be able to communicate through one or more communication channels. The data processing system 200 may communicate directly with other data processing systems 270 (e.g., via a direct wireless or wired connection), or via the one or more networks 260.

A communication channel may include any direct or indirect data connection path, including any connection using a wireless technology (e.g., Bluetooth, infrared, WiFi, WiMAX, cellular, 3G, 4G, EDGE, CDMA and DECT), any connection using wired technology (including via any serial, parallel, wired packet-based communication protocol (e.g., Ethernet, USB, FireWire, etc.), or other wireline connection), any optical channel (e.g., via a fiber optic connection or via a line-of-sight laser or LED connection), and any other point-to-point connection capable of transmitting data.

Each of the networks 260 may include one or more communication channels. In general, a network, or data network, consists of one or more communication channels. Examples of networks include LANs, MANs, WANs, cellular and mobile telephony networks, the Internet, the World Wide Web, and any other information transmission network. In various implementations, the data processing system 200 may include interfaces and communication ports in addition to the I/O ports 210.

The exemplary data processing system 200 may further include a display 212, which provides the ability for a user to visualize data output by the data processing system 200 and/or to interact with the data processing system 200. The display 212 may directly or indirectly provide a graphical user interface (GUI) adapted to facilitate presentation of data to a user and/or to accept input from a user. The display 212 may consist of a set of visual displays (e.g., an integrated LCD, LED or CRT display), a set of external visual displays, (e.g., an LCD display, an optical projection device, a holographic display), or of a combination of the foregoing.

A visual display may also be denoted a graphic display, computer display, display, computer screen, screen, computer panel, or panel. Examples of displays include a computer monitor, an integrated computer display, electronic paper, a flexible display, a touch panel, a transparent display, and a three dimensional (3D) display that may or may not require a user to wear assistive 3D glasses.

A data processing system may incorporate a graphic display. Examples of such data processing systems include a laptop, a computer pad or notepad, a tablet computer, an electronic reader (also denoted an e-reader or ereader), a smart phone, a personal data assistant (PDA), or other similar devices.

A data processing system may be connected to an external graphic display. Examples of such data processing systems include a desktop computer, a server, an embedded data processing system, or any other data processing system, provided that such data processing is adapted (itself or through an interface) to produce data that may be shown to a user. A data processing system may be connected to an external display regardless of whether it itself incorporates a graphic display. A data processing system may directly display data on an external display, or may transmit data to other data processing systems or logic modules that will eventually display data on an external display.

Graphic displays may include active display, passive displays, LCD displays, LED displays, OLED displays, plasma displays, and any other type of visual display that is capable of displaying electronic information to a user. Such graphic displays may permit direct interaction with a user, either through direct touch by the user (e.g. a touch-screen display that can sense a user's finger touching a particular area of the display), through proximity interaction with a user (e.g., sensing a user's finger being in proximity to a particular area of the display), or through a stylus or other input device. In one implementation, the display 212 is a touch-screen display that displays a human GUI interface to a user, with the user being able to control the data processing system 200 through the human GUI interface, or to otherwise interact with, or input data into the data processing system 200 through the human GUI interface.

The exemplary data processing system 200 may further include one or more human input interfaces 214, which facilitate data entry by a user or other interaction by a user with the data processing system 200. Examples of human input devices 214 include a keyboard, a mouse (whether wired or wireless), a stylus, other wired or wireless pointer devices (e.g., a remote control), or any other user device capable of interfacing with the data processing system 200. In some implementations, human input devices 214 may include one or more sensors that provide the ability for a user to interface with the data processing system 200 via voice, or provide user intention recognition technology (including optical, facial, or gesture recognition), or gesture recognition (e.g., recognizing a set of gestures based on movement via motion sensors such as gyroscopes, accelerometers, magnetic sensors, optical sensors, etc.).

The data processing system 200 may further include one or more gyroscopes, accelerometers, magnetic sensors, optical sensors, or other sensors that are capable of detecting physical movement of the data processing system. Such movement may include larger amplitude movements (e.g., a device being lifted by a user off a table and carried away or elevation changes experienced by the data processing system), smaller amplitude movements (e.g., a device being brought closer to the face of a user or otherwise being moved in front of a user while the user is viewing content on the display, movement experienced by a vehicle within which the data processing system is located), or higher frequency movements (e.g., hand tremor of a human, vibrations caused by an engine). In the absence of internal motion sensors, or in addition to any internal motion sensors, the exemplary data processing system 200 may further be capable of receiving and processing information from external motion sensors such as gyroscopes, accelerometers, magnetic sensors, optical sensors, or other sensors that are capable of detecting physical movement of the data processing system.

The exemplary data processing system 200 may further include an audio interface 216, which provides the ability for the data processing system 200 to output sound (e.g., a speaker), to input sound (e.g., a microphone), or any combination of the foregoing.

The exemplary data processing system 200 may further include any other components that may be advantageously used in connection with receiving, processing and/or transmitting information.

In the exemplary data processing system 200, the data processor 202, dynamic memory 204, storage memory 206, I/O port 210, display 212, human input interface 214, audio interface 216, and logic module 221 communicate to each other via the data bus 219. In some implementations, there may be one or more data buses in addition to the data bus 219 that connect some or all of the components of data processing system 200, including possibly dedicated data buses that connect only a subset of such components. Each such data bus may implement open industry protocols (e.g., a PCI or PCI-Express data bus), or may implement proprietary protocols.

Some of the embodiments described herein may be presented in terms of algorithms and symbolic representations of operations on data bits within a computer memory. In general, an algorithm represents a sequence of steps leading to a desired result. Such steps generally require physical manipulations of physical quantities. Usually, though not necessarily, these quantities take the form of electrical or magnetic signals capable of being stored, transferred, combined, compared, and otherwise manipulated using appropriate electronic devices. Such signals may be denoted as bits, values, elements, symbols, characters, terms, numbers, or using other similar terminology.

When used in connection with the manipulation of electronic data, terms such as processing, computing, calculating, determining, displaying, or the like, refer to the action and processes of a computer system or other electronic system that manipulates and transforms data represented as physical (electronic) quantities within the system's registers and memories into other data similarly represented as physical quantities within the memories or registers of that system of or other information storage, transmission or display devices.

Various embodiments may be implemented using an apparatus or machine that executes programming instructions. Such an apparatus or machine may be specially constructed for the required purposes, or may comprise a general purpose computer selectively activated or reconfigured by a software application.

Algorithms discussed in connection with various embodiments are not inherently related to any particular computer or other apparatus. Various general purpose systems may be used with programs in different embodiments, or it may be advantageous to construct more specialized apparatus to perform the required method steps. The required structure for a variety of these systems will appear from the description provided in connection with the various embodiments discussed in this patent. In addition, embodiments of the present invention are not described with reference to any particular programming language, data transmission protocol, or data storage protocol. Instead, a variety of programming languages, transmission or storage protocols may be used to implement various embodiments of the invention.

In various implementations, the data processing system 200 described in connection with FIG. 2 may be the consumer device 192 and/or the consumer device 194 described in connection with FIG. 1.

In various implementations, the data processing system 200 described in connection with FIG. 2 may be, or may incorporate digital medium 112 and/or optimization system 110 from the embodiment of FIG. 1.

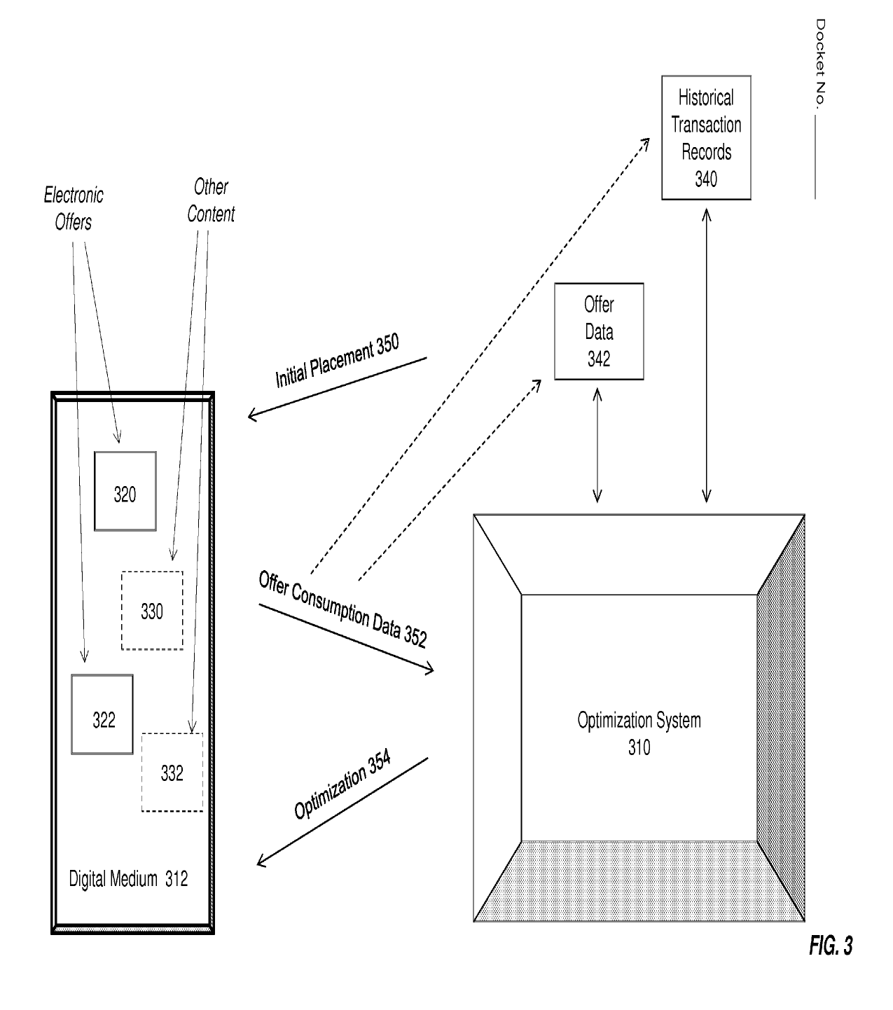

FIG. 3 shows a system for optimizing the placement of digital offers within a digital medium in accordance with an embodiment.

In the embodiment of FIG. 3, an optimization system 310 is adapted to optimize the placement of electronic offers 320 and 322 within a digital medium 312 based on a set of offer data 342 and a set of historical transaction records 340.

In one implementation, the optimization systems 310 is the optimization system 110 discussed in connection with the embodiment of FIG. 1. In various embodiments, the optimization system 310 may be a data processing system or logic module, or may be comprised in a data processing system or logic module. Data processing systems and logic modules were described in more detail in connection with the embodiment of FIG. 2.

In one implementation, the digital medium 312 is the digital medium 112 discussed in connection with the embodiment of FIG. 1. In various embodiments, the digital medium 312 may be a data processing system or logic module, or may be comprised in a data processing system or logic module.

In one implementation, the historical transaction records 340 are the historical transaction records 140 discussed in connection with the embodiment of FIG. 1. In one implementation, the offer data 342 is the offer data 142 discussed in connection with the embodiment of FIG. 1. Historical transaction records and offer data were discussed in more detail in connection with FIG. 1.

The digital medium 312 includes one or more digital offers, such as digital offers 320 and 322, and a set of other content items, such as content 330 and 332. In one implementation, the digital offers 320 and 322 correspond to the digital offers 120, 122 and 124 discussed in connection with the embodiment of FIG. 1. In one implementation, the items of content 330 and 332 correspond to the items of other content 130, 132 and 134 discussed in connection with the embodiment of FIG. 1.

As discussed in connection with the embodiment of FIG. 1, it is often necessary to optimize the placement of digital offers within a digital medium. Various ways in which the need for optimization may occur were discussed in more details in connection with the embodiment of FIG. 1. The optimization system 310 is adapted to optimize the placement of electronic offers 320 and 322 within the digital medium 312.

In one embodiment, the electronic offers 320 and 322 are initially placed within the digital medium 312 and are displayed to a consumer. This initial placement of electronic offers is illustrated if FIG. 3 as initial placement 350.

In one embodiment, the initial placement 350 of electronic offers includes an optimization process. In one embodiment, the optimization process used as part of the initial placement 350 is similar to the optimization 354 described below, and may be performed by the optimization system 310 or by another data processing system or logic module that is adapted to optimize the digital offers within the digital medium 312. In one embodiment, the initial optimization determines an initial placement scheme for digital offers based on at least a subset of the offer data and at least a subset of the historical transaction records.

In one embodiment, the initial optimization 350 does not actually include any substantive optimization, and is instead a random or ordered presentation format of digital offers. For example, digital offers may be presented to a consumer simply grouped by product manufacturer, sorted by discount amount, randomly, etc., but without any substantial optimization in terms of customizing the presentation based on historical transaction records or offer data for a particular consumer. With this approach, the optimization 354 would effectively be an initialization step for the optimization algorithm to be performed subsequently.

In general, in various embodiments, the initial placement of electronic offers (such as the electronic offers 320 and 322) within a digital medium (such as the digital medium 312) may be not optimized at all, optimized for one or more individual consumers at least to a certain degree based on offer data and/or historical transaction records (such as the offer data 342 and historical transaction records 340), or fully optimized for one or more individual consumers based on offer data and/or historical transaction records (such as the offer data 342 and historical transaction records 340).

In one embodiment, after the initial placement 350 of digital offers within the digital medium 312, the optimization system 310 then receives a set of offer consumption data, illustrated in FIG. 3 as the offer consumption data 352. The offer consumption data 352 may include offer data and/or historical transaction records that reflect, at least partially, the nature and level of interaction between the consumer and the digital offers presented to the consumer initially through the digital medium 312, such as activation, clipping, saving or redemption of one or more of the digital offers presented to the consumer. For example, the offer consumption data 352 may include a record of the number of electronic offers that were activated, clipped, clicked, saved, viewed, or redeemed by a consumer after being displayed to the consumer via the digital medium 312.

In one embodiment, the offer consumption data 352 is used to update the historical transaction records 340 and the offer data 342 to reflect the new transaction-related and consumer-related information ascertained from the activities of the consumers that viewed the electronic offers made available via the digital medium 312. This optional update step is illustrated in FIG. 3 through dotted arrows. Continuous updating of historical transaction records and the offer data used as a basis for the optimization of digital offer placement can help increase the accuracy of consumer behavioral modeling, increase the probability of predicting consumer consumption of digital offers, and improve the current and future optimization of placement of digital offers within digital media.

In one embodiment, the optimization system 310 then performs a revised optimization of the digital offers presented to the consumer through the digital medium 312, illustrated in FIG. 3 as the optimization 354.

In one embodiment, the initial placement 350 does not occur, and the optimization system 310 does not receive any offer consumption data 352. In that embodiment, the optimization system 310 proceeds directly to the optimization 354, and the optimization system 310 performs the offer placement optimization based on the offer data 342 and/or historical transaction records 340.

In various embodiments, the optimization system 310 may use different approaches to perform the optimization 354.

In one embodiment, the optimization system 310 employs a machine learning algorithm to arrive at an optimal sort order or placement of the electronic offers. The machine learning may be done based on a set of offer data and a set of historical transaction records, such as the offer data 342 and the historical transaction records 340. In one embodiment, the machine learning algorithm seeks to learn or otherwise evaluate the probability that a particular consumer would print, activate and/or redeem a particular electronic offer.

In one embodiment, as part of a machine learning phase, the optimization system 310 evaluates various offer data and historical transaction records to determine for a particular consumer (a) what digital offers were presented to that consumer, (b) the offer data associated with those offers, and (c) what actions the consumer took in connection with those digital offers (e.g., whether the consumer clipped, activated, redeemed, saved for later, or otherwise interacted with the offer). In one implementation, the optimization system 310 divides this information into two disjoint data sets: a training dataset and a testing dataset.

In one implementation, the optimization system 310 uses the training data set to train a machine learning algorithm. Various machine learning algorithms are known in the art and may be applied in various embodiments.

In one embodiment, the optimization system 310 uses a bagged set of regression trees as the basis for the machine learning algorithm. In general, bagging is a machine learning algorithm that may be used to improve the stability and accuracy of machine learning in statistical classification and regression.

In one embodiment, the optimization system 310 uses a regularized logistic regression as the basis for the machine learning algorithm. In general, logistic regression is a probabilistic statistical classification model. Regularization of logistic regression may help further improve the performance of the machine learning process (e.g., regularization conditions could be used to exclude unlikely values).

In one implementation, the optimization system 310 uses the testing data set to derive parameters needed for tuning the machine learning algorithm by minimizing the error in the probability of prediction in the testing dataset.

In one embodiment, the optimization system 310 generates a probability score for a particular consumer that seeks to predict the probability that the consumer will be interested in a particular digital offer. In one implementation, the digital offers presented to the consumer on the digital medium 312 are sorted in a descending order of this probability.

In one embodiment, the optimization system 310 applies a set of heuristics to supplement the machine learning algorithm analysis. In one implementation, one or more such heuristics are factored in using a function, such as the sigmoid function. In one embodiment, the input to such a function is a set of parameters relevant to the heuristic, and the output of the function is used to promote or demote digital offers in the order in which the offers are presented to a user through a digital medium 312. As a result, the optimization system 310 may generate a framework for optimizing the placement of one or more digital offers within a digital medium in a manner customized for a particular set of consumers.

In an embodiment, the optimization system 310 produces an optimized framework for the placement of one or more digital offers based at least in part on a measure of revenue associated with the activation, recommendation, and/or redemption of one or more previous digital offers. In an embodiment, optimized framework may be biased to be more favorable to an offer distributor, an offer provider, and/or a consumer. In an embodiment, an optimized framework for the placement of digital offers is based on a comparison of the historical performance of an offer to average offer performance across a plurality of offers. In an embodiment, more than one optimized frameworks for the placement of digital offers are determined for a consumer by optimizing one or more metrics to be more favorable to a set of consumers, a set of retailers, and/or a set of offer providers.

In an embodiment, an optimized framework for the placement of digital offers is further adjusted to artificially increase the placement ranking of a particular offer. In an embodiment, one or more digital offers are distributed in response to a request for a receipt. In an embodiment, a digital offer is included in a transaction receipt transmitted to a customer data processing system.

In an embodiment, an optimized framework for the placement of digital offers is further weighted by applying weights to the ranking one or more digital offers. In an embodiment, at least one weight is adapted to increase offer-related revenue for an offer distributor, to increase an offer discount for a customer, or to increase a profit margin of a retailer or of an offer provider. In an embodiment, at least one weight is modified based on feedback from at least one of the following: an offer redemption, an offer activation, or a purchase. In an embodiment, at least one weight is based on a set of offer data and/or a set of historical transaction records. In an embodiment, an optimized framework for the placement of digital offers is further biased based on an item-to-item correlation, offer-to-item correlation, consumer-centric correlation, item-to-event correlation, event-to-event correlation, consumer-to-event correlation, or measure of the frequency of co-occurrence of a set of digital offers or consumer actions.

In an embodiment, an optimized framework for the placement of digital offers is further adjusted based on a historical or projected impact of an offer on sales of an item, a historical or projected offer redemption rate, a historical or projected profit per offer impression, a historical or projected profit margin, a historical or projected offer volume, a historical or projected offer yield, a historical trend in offers made available by an offer provider, a historical or projected profit margin for the offer distributor, a historical or projected profit margin for an offer provider, a historical or projected impact of an offer on other offers, or a historical or projected impact of an offer on consumer behavior.

In an embodiment, an optimized framework for the placement of digital offers is further biased based on comparing historical performance of an offer to average offer performance for multiple offers in a group of offers. In an embodiment, an optimized framework for the placement of digital offers is further modified based on a function of activations, redemptions, and/or impressions of a set of electronic offers. In an embodiment, an optimized framework for the placement of digital offers is further adjusted based on a function of a product or offer inventory and/or an offer end date.

In an embodiment, an optimized framework for the placement of digital offers is further adjusted by determining different weights for different contexts in which digital offers may be presented to a consumer.

In various embodiments, the optimization of the placement of digital offers performed by the optimization system 310 may be achieved using at least in part any suitable optimization algorithm known in the art.

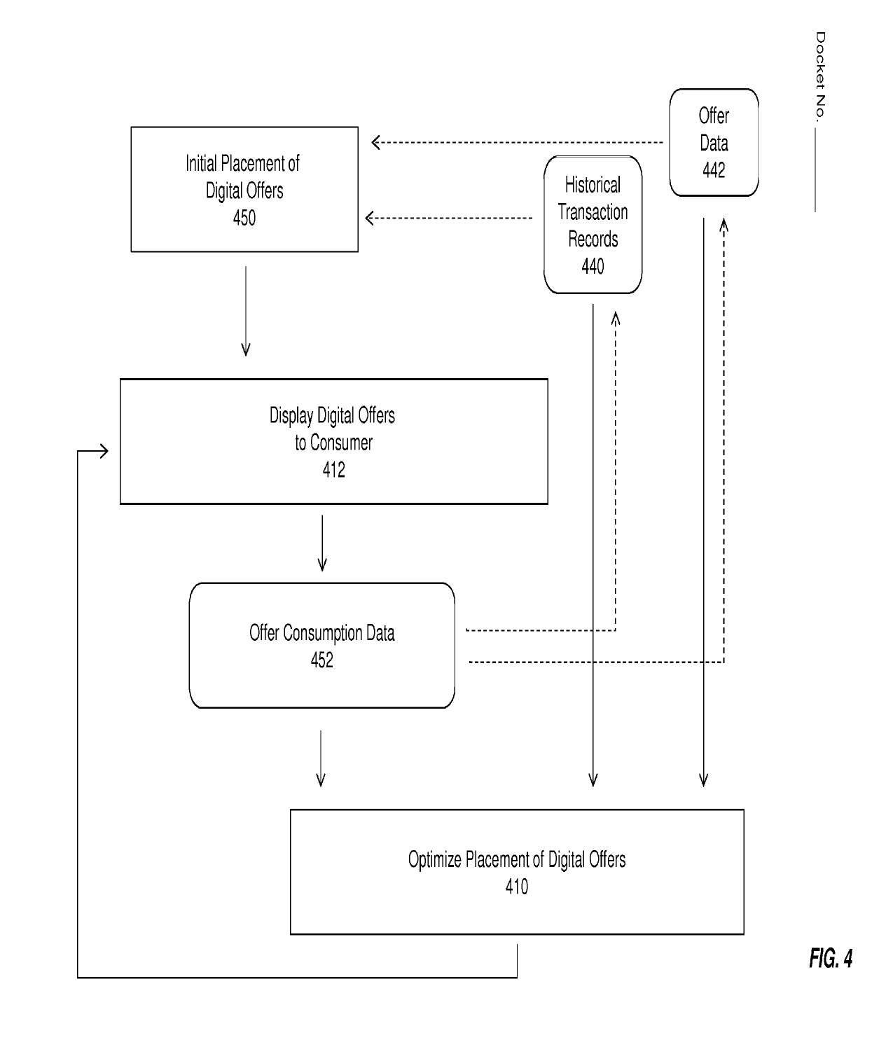

FIG. 4 shows a method, process and flow for optimizing the placement of digital offers within a digital medium in accordance with an embodiment.

In various embodiments, the method, process and flow from the embodiment of FIG. 4 may be performed using one or more data processing systems and/or logic modules. Data processing systems as logic modules were discussed in more detail in connection with FIG. 2.

In one embodiment, the method, process and flow from the embodiment of FIG. 4 illustrate the optimization that may be performed by the embodiment illustrated in FIG. 3, as discussed in more detail in connection with FIG. 3.

In the embodiment of FIG. 4, digital offers may be initially placed within a digital medium at step 450. In various embodiments, the placement of digital offers in step 450 may be achieved as discussed in connection with the initial placement 350 from FIG. 3.

The initial placement of digital offers at step 450 may be based on a set of historical transaction records received at step 440 and/or a set of offer data received at step 442. In various embodiments, the initial placement of digital offers within a digital medium at step 450 may or may not include an initial optimization process. Optimization of offer placement was described in more detail in connection with the initial placement 350 and optimization 354 in the embodiment of FIG. 3.

At step 412, the digital offers placed at step 450 may be displayed to one or more consumers via a digital medium. Displaying digital offers to consumers may be achieved as discussed in more detail in connection with the digital medium 112 from FIG. 1 and/or digital medium 312 from FIG. 3.

At step 452, a set of offer consumption data may be determined based on the interaction of one or more consumers with the offers displayed at step 412. The offer consumption data determined at step 452 may include offer data and/or historical transaction records that reflect, at least partially, the nature and level of interaction between one or more consumers and the digital offers presented to the consumers at step 412, such as activation, clipping, saving or redemption of one or more of the digital offers.

The offer consumption data determined at step 452 may be used to update the historical transaction records 440 and/or the offer data 442, as discussed in connection FIG. 3.

At step 410, the placement of the digital offers is optimized based on the set of historical transaction records received at step 440 and/or the set of offer data received at step 442. The optimization of digital offers at step 410 may be further based on the offer consumption data determined at step 452.

In various embodiments, the optimization of the placement of digital offers at step 410 is performed as discussed in more detail in connection with the optimization system 110 from FIG. 1 and/or the optimization system 310 from FIG. 3.

In one embodiment, once the optimization of the placement of digital offers has been achieved to the degree desired in step 410, the optimized placement framework may be used to display the digital offers to one or more consumers, possible as described at step 412. Further optimization may continue to be performed, with iterative improvement in the relevant optimization metrics and/or with continuous refinement of historical transaction records and/or offer data.

This specification describes in detail various embodiments and implementations of the inventions claimed in the claims, and the inventions claimed in the claims are open to additional embodiments and implementations, further modifications, and alternative and/or complementary constructions. There is no intention in this patent to limit the inventions claimed in the claims to the particular embodiments and implementations disclosed; on the contrary, this patent is intended to cover all modifications, equivalents and alternative embodiments and implementations that fall within the scope of the claims.

As used in this specification, a set means any group of one, two or more items. Analogously, a subset means, with respect to a set of N items, any group of such items consisting of N−1 or less of the respective N items.

As used in this specification, the terms “include,” “including,” “for example,” “exemplary,” “e.g.,” and variations thereof, are not intended to be terms of limitation, but rather are intended to be followed by the words “without limitation” or by words with a similar meaning. Definitions in this specification, and all headers, titles and subtitles, are intended to be descriptive and illustrative with the goal of facilitating comprehension, but are not intended to be limiting with respect to the scope of the inventions as recited in the claims. Each such definition is intended to also capture additional equivalent items, technologies or terms that would be known or would become known to a person of average skill in this art as equivalent or otherwise interchangeable with the respective item, technology or term so defined. Unless otherwise required by the context, the verb “may” or “could” indicates a possibility that the respective action, step or implementation may or could be achieved, but is not intended to establish a requirement that such action, step or implementation must occur, or that the respective action, step or implementation must be achieved in the exact manner described.

What is claimed is:

1. A system for optimizing the placement of at least one digital offer on a digital medium, the system comprising:
a first logic module adapted to receive a set of historical transaction records and a set of offer data;
a second logic module adapted to place a set of digital offers on a digital medium;
a third logic module adapted to receive a set of offer consumption data, the offer consumption data including information relating to at least one interaction between a consumer and the set of digital offers; and
a fourth logic module adapted to optimize the placement of at least a subset of the digital offers on the digital medium for that consumer, wherein the optimization is based on one or more of the following: at least a subset of the historical transaction records; at least a subset of the offer data; and at least a subset of the offer consumption data.

2. The system of claim 1, wherein the historical transaction records include at least one of the following: a universal product code, a quantity of product purchased, a number of items purchased, a transaction amount, at least a portion of a credit card number used, at least a portion of an account identifier, a payment identifier, a secure payment hash key, a data processing system or facility, time, date, one or more offers activated or redeemed, a consumer name, at least a portion of a phone number, a pin number, a password, a code, a loyalty card number, RFID data, a device identifier, one or more items that were purchased in a previous, concurrent or subsequent transaction, a transaction number, consumer tenure, consumer past behavior, consumer purchasing tendencies, the type and number of digital coupons activated, redeemed or printed by a consumer in a particular timeframe, the number of unique offers activated, redeemed or printed by a consumer, consumer search behavior, consumer purchase transaction behavior, consumer web browsing behavior, consumer digital offer activation behavior, consumer digital offer redemption behavior, an IP number of a digital processing system, a Universal Product Code (UPC), a stock-keeping unit (SKU) number, a taxonomical categorization, a product name, a product description, nutritional information of a product, a product specifications, a product price history, or an inventory level.

3. The system of claim 1, wherein the offer data includes at least one of the following: an offer provider identity, a historical or projected impact of the offer on sales of an item, a historical or projected offer redemption rate, a historical or projected profit per offer impression, a historical or projected profit margin, a historical trend in offers made available by an offer provider, a historical or projected offer volume, a historical or projected number of offer activations, a historical or projected number of offer impressions, a historical or projected number of offer redemptions, a historical or projected number of products sold, a historical or projected offer yield, a historical or projected profit figure, a historical or projected trend in offers made available by an offer provider, a historical or projected profit margin for an offer distributor, a historical or projected profit margin for an offer provider, a historical or projected impact of an offer on other offers, a historical or projected impact of an offer on consumer behavior, the savings value of a digital offer, the click-through rate of a digital offer, the household penetration of a product offered by a digital offer, an offer provider identity, a historical or projected impact of an offer on sales of an item, a historical or projected offer redemption rate, or a historical or projected profit per offer impression.

4. The system of claim 1, wherein the digital medium is a website, a portion of a web page, a software application running on a data processing system, an advertising display, a television or video device, a television or video broadcast, an electronic game, a kiosk, or a wearable device with display capability.

5. The system of claim 4, wherein the data processing system is a desktop computer, laptop computer, netbook, electronic notebook, ultra mobile personal computer (UMPC), electronic tablet, client computing device, client terminal, client console, server computer, server system, server terminal, cloud computing system, parallel processing or other distributed computing system, virtual machine, remote computer, mobile telephone, smartphone or similar device, wearable computer, head mounted computer or display, personal digital assistant, personal digital organizer, handheld device, or a networking device.

6. The system of claim 4, wherein the software application is a mobile app.

7. The system of claim 1, wherein the offer consumption data includes offer data, and wherein such offer data includes a record of the number of electronic offers that were activated, clipped, clicked, saved, viewed, or redeemed by a consumer after accessing such electronic offers through the digital medium.

8. The system of claim 1, wherein the offer consumption data includes historical transaction records, and wherein such historical transaction records include a record of the number of electronic offers that were activated, clipped, clicked, saved, viewed, or redeemed by a consumer after accessing such electronic offers through the digital medium.

9. The system of claim 1, wherein the optimization of the placement of at least a subset of the digital offers includes at least one of the following:
using a machine learning algorithm to arrive at an optimal sort order or placement of the electronic offers within the digital medium;
evaluating the probability that a particular consumer would print, activate and/or redeem a particular electronic offer;
a machine learning phase;
determining for a particular consumer at least one of the following: what digital offers were presented to that consumer; offer data associated with digital offers presented to the consumer; and an action taken by the consumer in connection with the digital offers presented to the consumer;
using a training data set to train a machine learning algorithm;
using a bagged set of regression trees as the basis for a machine learning algorithm; using a regularized logistic regression as the basis for a machine learning algorithm; using a testing data set to derive parameters for tuning a machine learning algorithm; or generating a probability score for a particular consumer that seeks to predict the
probability that the consumer will be interested in a particular digital offer;

10. The system of claim 1, wherein the optimization of the placement of at least a subset of the digital offers includes applying a set of heuristics to supplement a machine learning algorithm analysis.

11. The system of claim 10, wherein applying the set of heuristics includes factoring one or more of the heuristics using a function.

12. The system of claim 11, wherein:
the function is a sigmoid function;
the input to the function is a set of parameters relevant to a heuristic; or
the output of the function is used to promote or demote digital offers in the placement of the offers within the digital medium;

13. The system of claim 1, wherein the optimization of the placement of at least a subset of the digital offers includes at least one of the following:
evaluating the revenue associated with the activation, recommendation, and/or redemption of one or more previous digital offers;
biasing the placement of offers to be more favorable to an offer distributor, an offer provider, and/or a consumer;
comparing the historical performance of an offer to average offer performance across a plurality of offers;
determining a plurality of optimized frameworks for the placement of digital offers by optimizing one or more metrics to be more favorable to a set of consumers, a set of retailers, and/or a set of offer providers;
artificially increasing the placement ranking of a particular offer;
applying further weights to the ranking of one or more digital offers;
adjusting the placement of one or more digital offers based on a historical or projected impact of a digital offer on sales of an item, a historical or projected offer redemption rate, a historical or projected profit per offer impression, a historical or projected profit margin, a historical or projected offer volume, a historical or projected offer yield, a historical trend in offers made available by an offer provider, a historical or projected profit margin for the offer distributor, a historical or projected profit margin for an offer provider, a historical or projected impact of an offer on other offers, or a historical or projected impact of an offer on consumer behavior.

14. A method for optimizing the placement of at least one digital offer on a digital medium, the method comprising:
receiving a set of historical transaction records and a set of offer
data; placing a set of digital offers on a digital medium;
receiving a set of offer consumption data, the offer consumption data including information relating to at least one interaction between a consumer and the set of digital offers; and
optimizing the placement of at least a subset of the digital offers on the digital medium for that consumer, wherein the optimization is based on one or more of the following: at least a subset of the historical transaction records; at least a subset of the offer data; and at least a subset of the offer consumption data.

15. The method of claim 14, wherein the historical transaction records include at least one of the following: a universal product code, a quantity of product purchased, a number of items purchased, a transaction amount, at least a portion of a credit card number used, at least a portion of an account identifier, a payment identifier, a secure payment hash key, a data processing system or facility, time, date, one or more offers activated or redeemed, a consumer name, at least a portion of a phone number, a pin number, a password, a code, a loyalty card number, RFID data, a device identifier, one or more items that were purchased in a previous, concurrent or subsequent transaction, a transaction number, consumer tenure, consumer past behavior, consumer purchasing tendencies, the type and number of digital coupons activated, redeemed or printed by a consumer in a particular timeframe, the number of unique offers activated, redeemed or printed by a consumer, consumer search behavior, consumer purchase transaction behavior, consumer web browsing behavior, consumer digital offer activation behavior, consumer digital offer redemption behavior, an IP number of a digital processing system, a Universal Product Code (UPC), a stock-keeping unit (SKU) number, a taxonomical categorization, a product name, a product description, nutritional information of a product, a product specifications, a product price history, or an inventory level.

16. The method of claim 14, wherein the offer data includes at least one of the following: an offer provider identity, a historical or projected impact of the offer on sales of an item, a historical or projected offer redemption rate, a historical or projected profit per offer impression, a historical or projected profit margin, a historical trend in offers made available by an offer provider, a historical or projected offer volume, a historical or projected number of offer activations, a historical or projected number of offer impressions, a historical or projected number of offer redemptions, a historical or projected number of products sold, a historical or projected offer yield, a historical or projected profit figure, a historical or projected trend in offers made available by an offer provider, a historical or projected profit margin for an offer distributor, a historical or projected profit margin for an offer provider, a historical or projected impact of an offer on other offers, a historical or projected impact of an offer on consumer behavior, the savings value of a digital offer, the click-through rate of
a digital offer, the household penetration of a product offered by a digital offer, an offer provider identity, a historical or projected impact of an offer on sales of an item, a historical or projected offer redemption rate, or a historical or projected profit per offer impression.

17. The method of claim 14, wherein the digital medium is a website, a portion of a web page, a software application running on a data processing system, an advertising display, a television or video device, a television or video broadcast, an electronic game, a kiosk, or a wearable device with display capability.

18. The method of claim 14, wherein the offer consumption data includes offer data, and wherein such offer data includes a record of the number of electronic offers that were activated, clipped, clicked, saved, viewed, or redeemed by a consumer after accessing such electronic offers through the digital medium.

19. The method of claim 14, wherein the offer consumption data includes historical transaction records, and wherein such historical transaction records include a record of the number of electronic offers that were activated, clipped, clicked, saved, viewed, or redeemed by a consumer after accessing such electronic offers through the digital medium.

20. The method of claim 14, wherein the optimization of the placement of at least a subset of the digital offers includes at least one of the following:
using a machine learning algorithm to arrive at an optimal sort order or placement of the electronic offers within the digital medium;
evaluating the probability that a particular consumer would print, activate and/or redeem a particular electronic offer;
a machine learning phase;
determining for a particular consumer at least one of the following: what digital offers were presented to that consumer; offer data associated with digital offers presented to the consumer; and an action taken by the consumer in connection with the digital offers presented to the consumer;
using a training data set to train a machine learning algorithm;
using a bagged set of regression trees as the basis for a machine learning algorithm; using a regularized logistic regression as the basis for a machine learning algorithm; using a testing data set to derive parameters for tuning a machine learning algorithm; or generating a probability score for a particular consumer that seeks to predict the probability that the consumer will be interested in a particular digital offer.

21. The method of claim 14, wherein the optimization of the placement of at least a subset of the digital offers includes applying a set of heuristics to supplement a machine learning algorithm analysis.

22. The method of claim 21, wherein applying the set of heuristics includes factoring one or more of the heuristics using a function.

23. The method of claim 22, wherein:
the function is a sigmoid function;
the input to the function is a set of parameters relevant to a heuristic; or
the output of the function is used to promote or demote digital offers in the placement of the offers within the digital medium;

24. The method of claim 14, wherein the optimization of the placement of at least a subset of the digital offers includes at least one of the following:
evaluating the revenue associated with the activation, recommendation, and/or redemption of one or more previous digital offers;
biasing the placement of offers to be more favorable to an offer distributor, an offer provider, and/or a consumer;
comparing the historical performance of an offer to average offer performance across a plurality of offers;
determining a plurality of optimized frameworks for the placement of digital offers by optimizing one or more metrics to be more favorable to a set of consumers, a set of retailers, and/or a set of offer providers;
artificially increasing the placement ranking of a particular offer;
applying further weights to the ranking of one or more digital offers;
adjusting the placement of one or more digital offers based on a historical or projected impact of a digital offer on sales of an item, a historical or projected offer redemption rate, a historical or projected profit per offer impression, a historical or projected profit margin, a historical or projected offer volume, a historical or projected offer yield, a historical trend in offers made available by an offer provider, a historical or projected profit margin for the offer distributor, a historical or projected profit margin for an offer provider, a historical or projected impact of an offer on other offers, or a historical or projected impact of an offer on consumer behavior.

25. One or more non-transitory computer-readable media storing program instructions adapted to optimize the placement of at least one digital offer on a digital medium, wherein execution of the program instructions by a data processing system causes:
receiving a set of historical transaction records and a set of offer
data; placing a set of digital offers on a digital medium;
receiving a set of offer consumption data, the offer consumption data including information relating to at least one interaction between a consumer and the set of digital offers; and
optimizing the placement of at least a subset of the digital offers on the digital medium for that consumer, wherein the optimization is based on one or more of the following: at least a subset of the historical transaction records; at least a subset of the offer data; and at least a subset of the offer consumption data.

26. The one or more non-transitory computer-readable media of claim 25, wherein the optimization of the placement of at least a subset of the digital offers includes at least one of the following:
using a machine learning algorithm to arrive at an optimal sort order or placement of the electronic offers within the digital medium;
evaluating the probability that a particular consumer would print, activate and/or redeem a particular electronic offer;
a machine learning phase;
determining for a particular consumer at least one of the following: what digital offers were presented to that consumer; offer data associated with digital offers presented to the consumer; and an action taken by the consumer in connection with the digital offers presented to the consumer;
using a training data set to train a machine learning algorithm;
using a bagged set of regression trees as the basis for a machine learning algorithm; using a regularized logistic regression as the basis for a machine learning algorithm; using a testing data set to derive parameters for tuning a machine learning algorithm; or generating a probability score for a particular consumer that seeks to predict the
probability that the consumer will be interested in a particular digital offer [symbol]
